(19) United States
(12) Patent Application Publication
(10) Pub. No.: US 2025/0363775 A1
(43) Pub. Date: Nov. 27, 2025

(54) GEOLOCALIZING OBLIQUE AERIAL IMAGERY

(71) Applicant: X Development LLC, Mountain View, CA (US)

(72) Inventors: Akshina Gupta, Warren, NJ (US); Charles Stephen Spirakis, Mountain View, CA (US); Qian Huang, Santa Clara, CA (US); Alexander Thebelt, London (GB); Naji Shajarisales, Pittsburgh, PA (US); Ali Ahmadalipour Lapvandani, Los Altos, CA (US)

(21) Appl. No.: 19/037,533

(22) Filed: Jan. 27, 2025

Related U.S. Application Data
(60) Provisional application No. 63/627,004, filed on Jan. 30, 2024.

(51) Int. Cl. G06V 10/74; G06F 16/535; G06V 10/25; G06V 20/17

(52) U.S. Cl. CPC G06V 10/761; G06F 16/535; G06V 10/25; G06V 20/17; G06V 2201/10

(57) ABSTRACT

Methods, systems, and apparatus for receiving an image file recording an image and a set of metadata, determining a search space based on one or more of at least a portion of the set of metadata and auxiliary data, generating a set of candidate images based on the search space, identifying a candidate image in the set of candidate images as a best matching image relative to the image, the candidate image being associated with a set of candidate metadata, providing a set of augmented metadata for the image based on the set of metadata and the set of candidate metadata, the set of augmented metadata including at least a portion of the set of candidate metadata, and outputting a geographic features file that is generated using the set of augmented metadata, the geographic features file including data representing one or more geographic features represented in the image file.

### CROSS-REFERENCE TO RELATED APPLICATION

This application claims the benefit under 35 U.S.C. § 119 (e) of U.S. Patent Application No. 63/627,004, filed on Jan. 30, 2024. The disclosure of the foregoing application is incorporated herein by reference in its entirety for all purposes.

### TECHNICAL FIELD

This specification generally relates to aerial imagery, and more particularly to geolocalizing oblique aerial imagery.

### BACKGROUND

Aerial imagery can be described as capturing images of a surface, and features and/or content thereon, from a location above the surface. For example, aerial imagery of the Earth can include capturing images of the surface of the Earth and features thereon using a camera that is located above the surface. For example, an aircraft (e.g., plane, drone, helicopter, balloon) can carry a camera that captures images (aerial images) of the Earth from an altitude above the Earth.

To make use of the aerial images, detailed information on the location of the camera, the pose of the camera, and the like can be needed. For example, to determine the features depicted in the image, a location of the camera and the pose of the camera relative to the surface of the Earth is needed. In many instances, the location of the camera can be provided using global positioning system (GPS) data that can provide a relatively precise location of the aircraft, and thus the camera, when the image is captured. However, the pose of the camera, or at least portions thereof, when the image was captured might not be available.

### SUMMARY

This specification describes systems, methods, devices, and other techniques relating to geolocalizing aerial imagery. More particularly, the technology of this application is directed to generating a geographic features file from an aerial image that is at least partially absent pose information.

In general, innovative aspects of the subject matter described in this specification can include actions of receiving an image file recording an image and a set of metadata associated with the image, determining a search space based on one or more of at least a portion of the set of metadata and auxiliary data, generating a set of candidate images based on the search space, identifying a candidate image in the set of candidate images as a best matching image relative to the image, the candidate image being associated with a set of candidate metadata, providing a set of augmented metadata for the image based on the set of metadata and the set of candidate metadata, the set of augmented metadata including at least a portion of the set of candidate metadata, and outputting a geographic features file that is generated using the set of augmented metadata, the geographic features file including data representing one or more geographic features represented in the image file. Other implementations of this aspect include corresponding systems, apparatus, and computer programs, configured to perform the actions of the methods, encoded on computer storage devices.

These and other implementations can each optionally include one or more of the following features: actions further include determining bounding box data using the set of augmented data, wherein the one or more geographic features represented within the geographic features file are at least partially located within a bounding box defined by the bounding box data; determining a search space, generating a set of candidate images, identifying a candidate image in the set of candidate images as a best matching image, and providing a set of augmented metadata for the image are performed in response to determining that the set of augmented data is absent at least a portion of pose data; each candidate image in the set of candidate images is generated using a multi-dimensional model of Earth; the search space is determined by processing the image through a search space machine learning (ML) model that outputs the search space; the search space includes sets of parameters and each candidate image in the set of candidate images is generated based on a respective set of parameters; identifying a candidate image in the set of candidate images as a best matching image relative to the image includes processing the image and each candidate image through an image similarity ML model that determines similarity scores, each similarity score representing a similarity between the image and a respective candidate image; and the candidate image is identified as the best matching image in response to the candidate image having a highest similarity score.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

Particular implementations of the subject matter described in this specification can be executed so as to realize one or more of the following advantages. For example, mechanically and computationally complex equipment for recording complete and accurate metadata, including complete pose data, can be avoided. That is, for example, implementations of the present disclosure avoid any need for structures and/or computational equipment on aircraft to completely and accurately record pose data for each image that is captured. As such, passengers of an aircraft can capture images (e.g., using handheld cameras). In this manner, the range of aircraft that can be used to capture images is broadened (e.g., aircraft without special equipment can be used) and resources are conserved. As another example, implementations of the present disclosure bound the search space for candidate images thereby limiting a number of the candidate images that are generated. In this manner, computational resources are conserved.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual representation of capturing images at oblique angles.

FIG. 2 depicts an image geolocalizing pipeline in accordance with implementations of the present disclosure.

FIG. 3 depicts an example bounding box module in accordance with implementations of the present disclosure.

FIG. 4 is a flow diagram of an example process in accordance with implementations of the present disclosure.

Like reference numbers and designations in the various drawings indicate like elements.

### DETAILED DESCRIPTION

The technology of this patent application is directed to geolocalizing aerial imagery. More particularly, the technology of this application is directed to generating a geographic features file from an aerial image that is at least partially absent pose information.

To provide context for implementations of the present disclosure, and as introduced above, aerial imagery of the Earth can include capturing images of the surface of the Earth and features thereon using a camera that is located above the surface of the Earth. For example, an aircraft (e.g., plane, drone, helicopter, balloon) can carry a camera that captures images (aerial images) of the Earth from an altitude above the Earth. In some instances, images can be captured directly above the Earth. In some instances, images can be captured at oblique angles relative to the Earth.

To make use of aerial images, the images can be geolocalized. In some examples, geolocalizing refers to determining features depicted in the images. Features can include natural features and manmade features (collectively, geographic features). To geolocalize aerial images that are taken from oblique angles relative to the Earth, detailed information on the location of the camera, the pose of the camera, and the like can be needed. For example, to determine the geographic features depicted in the image, a location of the camera and the pose of the camera relative to the surface of the Earth is needed.

In some examples, a geographic features file can be generated from an image based on location information and pose information, the geographic features file recording geographic data that represents geographic features depicted in the image. The geographic features file can be provided in a format, such as GeoJSON. GeoJSON can be described as a geospatial data interchange format that is based on JavaScript Object Notation (JSON). GeoJSON defines several types of JSON objects and how they are combined to provide geographic data that represents geographic features (e.g., natural features, manmade features) as well as the properties and spatial extents of the geographic features. Further detail on GeoJSON is provided in RFC 7946, published by the Internet Engineering Task Force (IETF) in August 2016.

In many instances, the location of the camera can be provided using global positioning system (GPS) data that can provide a relatively precise location of the aircraft, and thus the camera, when the image is captured. However, the pose of the camera, or at least portions thereof, and/or other information that may be related to when the image was captured might not be available. Images that are absent pose data, or at least a portion thereof, cannot be readily geolocalized. Consequently, systems for capturing aerial images from oblique angles can be relatively complex (e.g., mechanically, computationally) to ensure that an entirety of pose data is recorded for each image. As a result, aircraft that are able to capture aerial images with an entirety of pose data can be costly and rare.

In view of the foregoing, implementations of the present disclosure provide an image geolocalizing pipeline to generate a geographic features file (e.g., GeoJSON file) from an image that is at least partially absent pose data. In some implementations, and as described in further detail herein, the image geolocalizing pipeline generates a set of candidate images based on an actual image (i.e., an image depicting the surface of the Earth), each candidate image having candidate pose data associated therewith and uses one or more ML models to select a candidate image from the set of candidate images. For example, the one or more ML models compare the actual image to each of the one or more candidate images and selects the candidate image that is determined to be most similar to the actual image. In some examples, the candidate pose data of the (selected) candidate image is at least partially attributed to the actual image. That is, at least a portion of the candidate pose data of the candidate image is used as pose data for the actual image. In some implementations, the image geolocalizing pipeline of the present disclosure further includes identifying features depicted in the actual image and recording the features in a geographic features file (e.g., GeoJSON file).

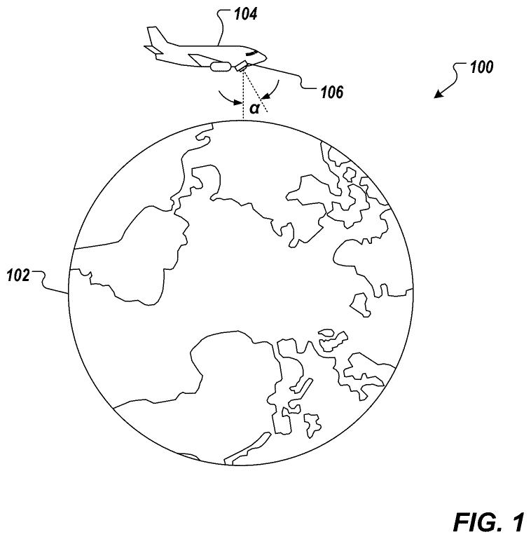

FIG. 1 is a conceptual representation 100 of capturing images at oblique angles. The conceptual representation 100 includes the Earth 102, an aircraft 104 flying above the Earth 102, and a camera 106 associated with the aircraft 104 to capture images of the Earth. For example, the camera 106 can be mounted (e.g., fixedly, movably) to the aircraft 104. As another example, the camera 106 can be a handheld camera (e.g., a passenger within the aircraft 104 holding the camera). In some examples, the camera 106 can be any appropriate type of camera that can capture images that are stored in a computer-readable digital image file.

As represented in FIG. 1, the field-of-view (FOV) of the camera 106 is at an angle a relative to a surface of the Earth, where α≠0. That is, instead of the FOV pointing straight-down toward the surface of the Earth, the camera 106 is at the angle α. As such, images captured by the camera 106 are at an oblique angle (the angle α) relative to the surface of the Earth.

In some implementations, an image captured by the camera 106 (also referred to as an actual image) includes metadata associated therewith, the metadata representing location data and/or pose data. Example metadata is provided in Table 1:

TABLE 1
Example Image Metadata

| Metadata | Variable | Description |
|---|---|---|
| Latitude | lat | float, [−90, 90] |
| | | (degrees) |
| Longitude | lon | float, [−180, 180] |
| | | (degrees) |
| Altitude | alt | float (meters) |
| Focal Length | focal_length_35 mm | float |
| (35 mm equivalent) | | |
| Pixel Width of Image | width | float |
| Pixel Height of Image | height | float |
| Tilt of Camera Pose | tilt | float, [0, 90] |
| (Pitch) | | (degrees) |
| Heading of Camera | heading | float, [−180, 180] |
| Pose (Yaw) | | (degrees from North) |
| Roll of Camera Pose | roll | float |
| FOV in y-Direction | fov_y | float, [0, 180] |

In some examples, metadata can be recorded by the camera 106 when capturing an image. For example, and without limitation, the camera 106 can record focal length, pixel width, and pixel height. As another example, the camera 106 can record FOV (e.g., based on focal length and size of sensor used to capture images). As another example, the camera 106 can record latitude and longitude (e.g., in instances where the camera 106 is associated with a GPS module, such as a smartphone having the camera 106 therein). As another example, the camera 106 can record altitude (e.g., in instances where the camera 106 is associated with a barometric altimeter).

In some examples, metadata can be recorded external to the camera 106 when capturing an image and can be added to the image file. For example, and without limitation, the aircraft 104 (e.g., sensors thereon) can record latitude, longitude, and/or altitude when an image is captured and the values can be populated as metadata in the image file that records the image.

In some examples, at least a portion of the metadata, including pose data, is not recorded for an image when the image is captured. For example, and without limitation, an image can be captured and can be absent longitude, latitude, altitude, tilt, heading, and/or roll. For example, it can occur that sensors necessary for recording one or more of longitude, latitude, altitude, tilt, heading, and/or roll for the camera 106, among other metadata, are absent.

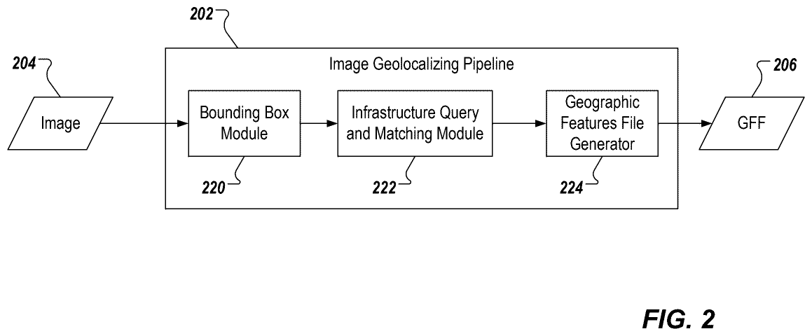

FIG. 2 depicts an image geolocalizing pipeline 202 in accordance with implementations of the present disclosure. In some examples, the image geolocalizing pipeline 202 can be provided as a cloud-based service (e.g., a Google Cloud Platform (GPC) service) that receives an image 204 (e.g., a computer-readable image file) and processes the image 204 to provide a geographic features file (GFF) 206 (e.g., a GeoJSON file). For example, and without limitation, the image geolocalizing pipeline 202 can periodically check (e.g., x times per day) an image store for the presence of new images (e.g., images that have been added to the image store and have not yet been processed). When a new image is detected, the image can be copied to a dedicated storage bucket for processing. In some examples, an alert is sent to the image geolocalizing pipeline 202 when an image is added to the image store and in response to the alert, the image can be copied to the dedicated storage bucket for processing.

In the example of FIG. 2, the image geolocalizing pipeline 202 includes a bounding box module 220, an infrastructure query and matching module 222, and a geographic features file generator 224. As described in further detail herein, the bounding box module 220 receives the image 204, geolocates the image 204, and generates a bounding box for the image 204. In some examples, the bounding box maps a frame of reference of the image to coordinates.

The infrastructure query and matching module 222 processes the bounding box to identify, for example and without limitation, geographic features, such as manmade features, populating the bounding box. Example manmade features can include infrastructure and/or resources, such as roads, buildings, bridges, and the like. Example infrastructure can be described as Critical Infrastructure and Key Resources (CIKR) that is represented in multiple categories as published by the Cybersecurity and Infrastructure Security (CISR) Agency of the United States. For example, the bounding box can be used to query an asset dataset to identify assets located within the bounding box. In some examples, features with known locations (latitude and longitude) and listed in the Homeland Infrastructure Foundation-Level Data (HIFLD) dataset (asset dataset), provided by the U.S. Department of Homeland Security, are identified within the bounding box. In some examples, assets located in the bounding box can be represented in a query to a CIKR database that returns a query result representing CIKR categories, if any, for assets located within the bounding box. That is, for example, assets in the bounding box can be categorized into CIKR categories.

In some implementations, the geographic features file generator 224 generates the GFF 206 based on the image 204, the assets, and the CIKR categories, if any. For example, the GFF 206 can include GeoJSON tags as represented in the below example:

Listing 1: Example GeoJSON Tags for GFF

```
{
  “type”:“FeatureCollection”,
  “features”:
    [
      {“type”: “Feature”, “geometry”:{ “type”: “Point”,
“coordinates”: [ −86.5593171, 35.9231227] }, “properties”:
{“name”: “Stewarts Creek High School”, “sector”:
“Government Facilities”, “associated_images”:
[“DSC_1011.JPG”] } },
      {“type”: “Feature”, “geometry”:{ “type”: “LineString”,
“coordinates”: [ [ −87.608051, 35.975516 ], [ −87.607752,
35.974770] ] }, “properties”: { “name”: “Indian Creek Road”,
“sector”: “Transportation”, “associated_images”:
[“DSC_0577.JPG”] } }
    ]
}
```

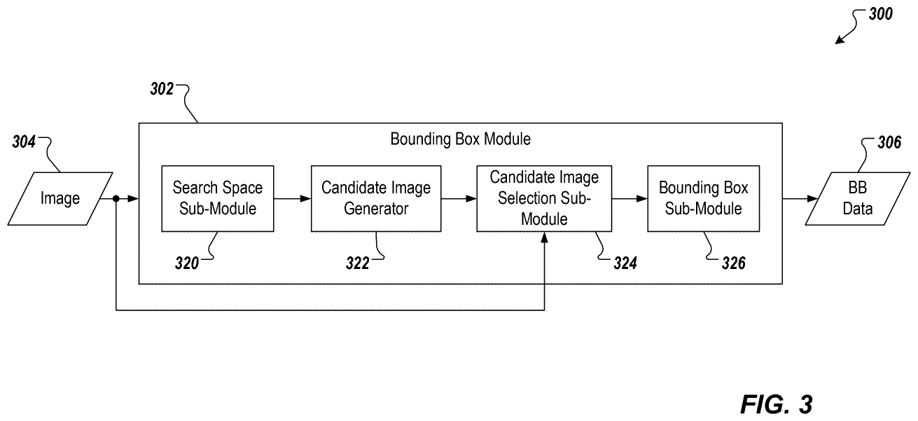

FIG. 3 depicts an example bounding box module 302 in accordance with implementations of the present disclosure. The bounding box module 302 can be provided as the bounding box module 220 of FIG. 2. In the example of FIG. 3, the bounding box module 302 includes a search space sub-module 320, a candidate image generator 322, a candidate image selection sub-module 324, and a bounding box sub-module 326.

In accordance with implementations of the present disclosure, the bounding box module 302 receives an image 304 (e.g., the image 204 of FIG. 2) and provides bounding box (BB) data 306. In some examples, the BB data 306 includes geographic coordinates of a bounding box of a geographic area represented in the image 304. In some examples, the bounding box is provided as a geometric shape (e.g., triangle, square, rectangle) having multiple vertices, each vertex being associated with geographic coordinates (latitude, longitude).

In some implementations, the bounding box module 302 determines whether the image 304 is absent metadata that can be required to determine the bounding box. For example, the bounding box module 302 can determine whether at least a subset of metadata for the image 304 is complete (e.g., each metadata in the subset of metadata is populated with a value). The subset of metadata can include metadata (e.g., pose data) that is required to geolocalize the image. In some examples, if the subset of metadata is complete, the image 304 is provided to the bounding box sub-module 326 to provide the BB data 306.

If the subset of metadata for the image 304 is not complete, the image 304 is provided to the search space sub-module 320. In some examples, the search space sub-module 320 determines a search space for the generation of a set of candidate images. For example, and as described in further detail herein, a set of candidate images is provided, each candidate image being a simulated image of the Earth that is generated from a multi-dimensional model of the Earth (or at least portion of the Earth). The search space can be described as a geographical space that provides a boundary from within which the candidate images are generated. The search space limits potential candidate images to avoid candidate images being generated that are not relevant to the image 304 (e.g., candidate images that would not be a match to the image 304). In this manner, a number of the candidate images in the set of candidate images is limited and technical resources are conserved (e.g., conserving processors, memory, bandwidth, etc. that would otherwise be expended to generate candidate images that are not relevant to the image 304).

In some examples, the search space is determined by the search space sub-module 320 based on metadata values and/or auxiliary data associated with the image 304. For example, auxiliary data can include a flightpath of the aircraft that the camera that captured the image 304, and the search space can be limited to locations along the flightpath. As another example, a location (latitude, longitude) at which the image 304 was captured can be provided in the metadata and the search space can be limited to locations within a threshold distance of the location. As another example, an altitude at which the image 304 was captured can be provided in the metadata and the search space can be limited to altitudes within a threshold distance of the altitude. Any appropriate combination of metadata values can be used to determine the search space. In some examples, a search space ML model can process the image 304 to determine the search space. For example, the search space ML model can process the image 304 and output a search space that is to be used for generating the candidate images.

In some examples, the search space can be provided as a set of parameter ranges that define a boundary from within which the candidate images are generated. Example parameter ranges that can be included in the search space are provided in Table 2:

TABLE 2
Example Set of Parameters

| Parameter | Range |
|---|---|
| Latitude | lat ± Δₗₐₜ |
| Longitude | lon ± Δₗₒₙ |
| Altitude | alt ± Δₐₗₜ |
| Compass Heading | deg ± Δ_{deg} |

In some implementations, the search space is provided to the candidate image generator 322, which generates a set of candidate images based on the search space. For example, the candidate image generator 322 can access a multi-dimensional model of the Earth (also referred to herein as Earth model) to generate candidate images, each candidate image corresponding to a set of parameters based on the parameter ranges. An example multi-dimensional model of the Earth can include, without limitation, Google Earth (also referred to as Geo3D) provided by Google LLC. For example, the candidate image generator 322 can determine sets of parameters and, for each set of parameters, make a call (e.g., API call) to a model service, which returns a candidate image for the set of parameters. Each candidate image is a simulated image of the Earth provided by the Earth model corresponding to the set of parameters. For example, each candidate image can be described as a synthetic drone image that is generated from the Earth model at a specific location, elevation, field of view, camera pose, etc. In some examples, in response to an API call, the model service renders an image of the Earth based on the set of parameters and returns the image as a candidate image.

Table 3 provides an example set of candidate images, in which the set of metadata includes values for longitude, latitude, and altitude, but is absent values for heading, tilt, heading, roll, and fov_y (e.g., the metadata for the image is [lon, lat, alt, -, -, -, -]):

TABLE 3
Example Candidate Images and Sets of Parameters

| Candidate | |
|---|---|
| Image | Set of Parameters |
| CI₁ | [lon, lat, alt, heading₁, tilt₁, roll₁, fov_y₁] |
| CI₂ | [lon, lat, alt, heading₂, tilt₂, roll₂, fov_y₂] |
| CI₃ | [lon, lat, alt, heading₃, tilt₃, roll₃, fov_y₃] |
| CI₄ | [lon + Δₗₒₙ₁, lat + Δₗₐₜ₁, alt + Δₐₗₜ₁, heading₁, |
| | tilt₁, roll₁, fov_y₁] |
| CI₅ | [lon + Δₗₒₙ₁, lat + Δₗₐₜ₁, alt + Δₐₗₜ₁, heading₂, |
| | tilt₂, roll₂, fov_y₂] |
| CI₆ | [lon + Δₗₒₙ₁, lat + Δₗₐₜ₁, alt + Δₐₗₜ₁, heading₃, |
| | tilt₃, roll₃, fov_y₃] |
| CI₇ | [lon − Δₗₒₙ₁, lat + Δₗₐₜ₁, alt + Δₐₗₜ₁, heading₁, |
| | tilt₁, roll₁, fov_y₁] |
| CI₈ | [lon − Δₗₒₙ₁, lat + Δₗₐₜ₁, alt + Δₐₗₜ₁, heading₂, |
| | tilt₂, roll₂, fov_y₂] |
| CI₉ | [lon − Δₗₒₙ₁, lat + Δₗₐₜ₁, alt + Δₐₗₜ₁, heading₃, |
| | tilt₃, roll₃, fov_y₃] |
| . . . | . . . |

In the example of Table 3, heading₁, . . . , heading₃, tilt₁, . . . , tilt₃, roll₁, . . . , roll₃, and fov_y₁, . . . , fov_y₃ are values selected by the candidate image generator 322 in view of values missing from the metadata, and Δₗₒₙ₁≤Δₗₒₙ, Δₗₐₜ₁ ≤Δₗₐₜ, Δₐₗₜ₁ ≤Δₐₗₜ. For example, and with reference to the example of Listing 2, [heading₁, tilt₁, roll₁, fov_y₁]=[10, 10, 0, 30], [heading₂, tilt₂, roll₂, fov_y₂]=[10, 20, 0, 30], and [heading₃, tilt₃, roll₃, fov_y₃]=[30, 20, 0, 30].

In accordance with implementations of the present disclosure, the image 304 and the set of candidate images are provided to the candidate image selection sub-module 324. In some examples, the candidate image selection sub-module 324 uses an image similarity ML model that compares the image 304 to each candidate image in the set of candidate images. In some examples, the image similarity ML model provides a set of similarity scores, each similarity score representing a degree of similarity between the image 304 and a respective candidate image. In some examples, the candidate image having the highest similarity score is determined to be a best match to the image 304.

In accordance with implementations of the present disclosure, at least a portion of the metadata of the candidate image that is selected as the best match is used to populate the set of metadata associated with the image 304 to provide a set of augmented metadata. For example, and as noted above, the set of metadata of the image 304 can be provided as [lon, lat, alt, -, -, -, -], where - indicates absence of metadata (e.g., absence of tilt, heading, roll, fov_y). It can be determined that that the candidate image CI₄ of Table 3 is the best match. Consequently, a set of augmented metadata for the image 304 can be provided as [lon, lat, alt, heading₁, tilt₁, roll₁, fov_y₁], keeping the original values for longitude, latitude, and altitude, and adding in the values for tilt, heading, roll, and fov_y from CI₄.

In some examples, the set of augmented metadata is provided to the bounding box sub-module 326, which determines the BB data 306 for the image 304.

In some implementations, the image 304 and the BB data 306 can be used to identify features located within the bounding box. For example, and as described herein, the infrastructure query and matching module 222 of FIG. 2 can process the BB data 306 to identify, for example and without limitation, geographic features, such as manmade features, populating the bounding box. Example manmade features can include infrastructure and/or resources, such as roads, buildings, bridges, and the like, which can be categorized into categories (e.g., CIKR categories). The geographic features file generator 224 of FIG. 2 generates the GFF 206 based on the image 204 (e.g., the image 304), the assets, and the CIKR categories, if any.

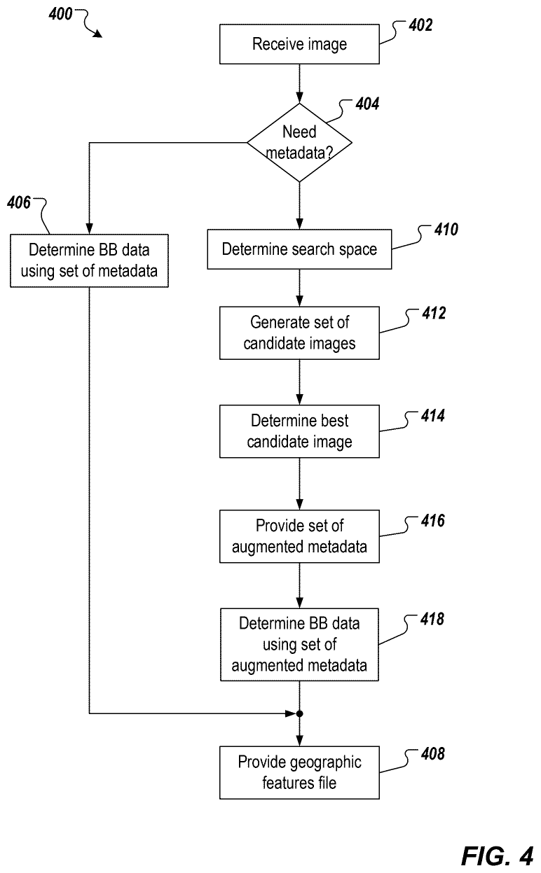

FIG. 4 is a flow diagram of an example process 400 in accordance with implementations of the present disclosure. In some examples, the example process 400 is provided using one or more computer-executable programs executed by one or more computing devices.

An image is received (402). For example, and as described herein with reference to FIG. 3, the bounding box module 302 receives the image 304. It is determined whether metadata is needed (404). For example, and as described herein, the bounding box module 302 determines whether the image 304 is absent metadata that can be required to determine the bounding box. For example, the bounding box module 302 can determine whether at least a subset of metadata for the image 304 is complete, where the subset of metadata includes metadata (e.g., pose data) that is required to geolocalize the image. For example, if the metadata for the image 304 includes values for each of [lon, lat, alt, heading, tilt, roll, fov_y], it is determined that metadata is not needed. As another example, if the metadata for the image 304 includes values for each of [lon, lat, alt], but is absent metadata for one or more of [heading, tilt, roll, fov_y], it can be determined that metadata is needed.

If metadata is not needed, BB data is determined using the set of metadata (406) and a geographic features file is provided (408). For example, and as described herein, the set of metadata is processed by the bounding box sub-module 326 to provide the BB data 306, which is processed by the infrastructure query and matching module 222 of FIG. 2 to identify assets (e.g., manmade features) within the bounding box and categorize assets (e.g., using CIKR categories). This information is provided to the geographic features file generator 224, which provides the GFF 206.

If metadata is needed, a search space is determined (410). For example, and as described herein, metadata and/or auxiliary data associated with the image 304 is used to determine the search space. The search space limits parameters within which candidate images are generated. A set of candidate images is generated (412). For example, and as described herein, the search space is provided to the candidate image generator 322 of FIG. 3, which generates a set of candidate images based on the search space. For example, the candidate image generator 322 can access an Earth model (e.g., Geo3D) to generate candidate images, each candidate image corresponding to a set of parameters based on parameter ranges. For example, the candidate image generator 322 can determine sets of parameters and, for each set of parameters, make a call (e.g., API call) to a model service, which returns a candidate image for the set of parameters. Each candidate image is a simulated image of the Earth provided by the Earth model corresponding to the set of parameters.

A best candidate image is determined (414). For example, and as described herein, the candidate image selection sub-module 324 uses an image similarity ML model that compares the image 304 to each candidate image in the set of candidate images. In some examples, the image similarity ML model provides a set of similarity scores, each similarity score representing a degree of similarity between the image 304 and a respective candidate image. In some examples, the candidate image having the highest similarity score is determined to be a best match to the image 304.

A set of augmented metadata is provided (416). For example, and as described herein, at least a portion of the metadata of the candidate image that is selected as the best match is used to populate the set of metadata associated with the image 304 to provide a set of augmented metadata. For example, and as noted above, the set of metadata of the image 304 can be provided as [lon, lat, alt, -, -, -, -], where - indicates absence of metadata (e.g., absence of tilt, heading, roll, fov_y). It can be determined that that the candidate image CI₄ of Table 3 is the best match. Consequently, a set of augmented metadata for the image 304 can be provided as [lon, lat, alt, heading₁, tilt₁, roll₁, fov_y₁], keeping the original values for longitude, latitude, and altitude, and adding in the values for tilt, heading, roll, and fov_y from CI₄.

BB data is determined using the set of augmented metadata (418) and a geographic features file is provided (408). For example, and as described herein, the augmented set of metadata is processed by the bounding box sub-module 326 to provide the BB data 306, which is processed by the infrastructure query and matching module 222 of FIG. 2 to identify assets (e.g., manmade features) within the bounding box and categorize assets (e.g., using CIKR categories). This information is provided to the geographic features file generator 224, which provides the GFF 206.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for geolocalizing aerial images, the method being executed by one or more processors and comprising:
receiving an image file recording an image and a set of metadata associated with the image;
determining a search space based on using one or more of at least a portion of the set of metadata and auxiliary data;
generating, using a multi-dimensional model, a set of simulated candidate images, each simulated candidate image corresponding to the search space;
identifying a simulated candidate image in the set of simulated candidate images as a best matching image relative to the image, the simulated candidate image being associated with a set of candidate metadata;
providing a set of augmented metadata for the image generated from the set of metadata and the set of candidate metadata, the set of augmented metadata comprising at least a portion of the set of candidate metadata; and
outputting a geographic features file that is generated using the set of augmented metadata, the geographic features file comprising data representing one or more geographic features represented in the image file.

2. The method of claim 1, wherein the set of metadata associated with the image is absent metadata required to geolocalize the image, wherein outputting the geographic features file further comprises:
determining bounding box data using the set of augmented data, wherein the one or more geographic features represented within the geographic features file are at least partially located within a bounding box defined by the bounding box data.

3. The method of claim 1, wherein determining a search space, generating a set of candidate images, identifying a candidate image in the set of candidate images as a best matching image, and providing a set of augmented metadata for the image are performed in response to determining that the set of augmented data is absent at least a portion of pose data.

4. The method of claim 1, wherein each candidate image in the set of candidate images is generated using a multi-dimensional model of Earth.

5. The method of claim 1, wherein the search space is determined by processing the image through a search space machine learning (ML) model that outputs the search space.

6. The method of claim 1, wherein the search space comprises sets of parameters and each candidate image in the set of candidate images is generated based on a respective set of parameters.

7. The method of claim 1, wherein identifying a candidate image in the set of candidate images as a best matching image relative to the image comprises processing the image and each candidate image through an image similarity ML model that determines similarity scores, each similarity score representing a similarity between the image and a respective candidate image.

8. The method of claim 7, wherein the candidate image is identified as the best matching image in response to the candidate image having a highest similarity score.

9. A non-transitory computer storage medium encoded with a computer program, the computer program comprising instructions that when executed by a data processing apparatus cause the data processing apparatus to perform operations for geolocalizing aerial images, the operations comprising:
receiving an image file recording an image and a set of metadata associated with the image;
determining a search space based on using one or more of at least a portion of the set of metadata and auxiliary data;
generating, using a multi-dimensional model, a set of simulated candidate images, each simulated candidate image corresponding to the search space;
identifying a simulated candidate image in the set of simulated candidate images as a best matching image relative to the image, the simulated candidate image being associated with a set of candidate metadata;
providing a set of augmented metadata for the image generated from the set of metadata and the set of candidate metadata, the set of augmented metadata comprising at least a portion of the set of candidate metadata; and
outputting a geographic features file that is generated using the set of augmented metadata, the geographic features file comprising data representing one or more geographic features represented in the image file.

10. The non-transitory computer storage medium of claim 9, wherein the set of metadata associated with the image is absent metadata required to geolocalize the image, wherein outputting the geographic features file, and wherein operations further comprise determining bounding box data using the set of augmented data, wherein the one or more geographic features represented within the geographic features file are at least partially located within a bounding box defined by the bounding box data.

11. The non-transitory computer storage medium of claim 9, wherein determining a search space, generating a set of candidate images, identifying a candidate image in the set of candidate images as a best matching image, and providing a set of augmented metadata for the image are performed in response to determining that the set of augmented data is absent at least a portion of pose data.

12. The non-transitory computer storage medium of claim 9, wherein each candidate image in the set of candidate images is generated using a multi-dimensional model of Earth.

13. The non-transitory computer storage medium of claim 9, wherein the search space is determined by processing the image through a search space machine learning (ML) model that outputs the search space.

14. The non-transitory computer storage medium of claim 9, wherein the search space comprises sets of parameters and each candidate image in the set of candidate images is generated based on a respective set of parameters.

15. The non-transitory computer storage medium of claim 9, wherein identifying a candidate image in the set of candidate images as a best matching image relative to the image comprises processing the image and each candidate image through an image similarity ML model that determines similarity scores, each similarity score representing a similarity between the image and a respective candidate image.

16. The non-transitory computer storage medium of claim 15, wherein the candidate image is identified as the best matching image in response to the candidate image having a highest similarity score.

17. A system, comprising:
one or more processors; and
a computer-readable storage device coupled to the one or more processors and having instructions stored thereon which, when executed by the one or more processors, cause the one or more processors to perform operations for geolocalizing aerial images, the operations comprising:
receiving an image file recording an image and a set of metadata associated with the image;
determining a search space based on using one or more of at least a portion of the set of metadata and auxiliary data;
generating, using a multi-dimensional model, a set of simulated candidate images, each simulated candidate image corresponding to the search space;
identifying a simulated candidate image in the set of simulated candidate images as a best matching image relative to the image, the simulated candidate image being associated with a set of candidate metadata;
providing a set of augmented metadata for the image generated from the set of metadata and the set of candidate metadata, the set of augmented metadata comprising at least a portion of the set of candidate metadata; and
outputting a geographic features file that is generated using the set of augmented metadata, the geographic features file comprising data representing one or more geographic features represented in the image file.

18. The system of claim 17, wherein the set of metadata associated with the image is absent metadata required to geolocalize the image, wherein outputting the geographic features file, and wherein operations further comprise determining bounding box data using the set of augmented data, wherein the one or more geographic features represented within the geographic features file are at least partially located within a bounding box defined by the bounding box data.

19. The system of claim 17, wherein determining a search space, generating a set of candidate images, identifying a candidate image in the set of candidate images as a best matching image, and providing a set of augmented metadata for the image are performed in response to determining that the set of augmented data is absent at least a portion of pose data.

20. The system of claim 17, wherein each candidate image in the set of candidate images is generated using a multi-dimensional model of Earth.

21. The system of claim 17, wherein the search space is determined by processing the image through a search space machine learning (ML) model that outputs the search space.

22. The system of claim 17, wherein the search space comprises sets of parameters and each candidate image in the set of candidate images is generated based on a respective set of parameters.

23. The system of claim 17, wherein identifying a candidate image in the set of candidate images as a best matching image relative to the image comprises processing the image and each candidate image through an image similarity ML model that determines similarity scores, each similarity score representing a similarity between the image and a respective candidate image.

24. The system of claim 23, wherein the candidate image is identified as the best matching image in response to the candidate image having a highest similarity score.

25. The method of claim 1, wherein determining the search space comprises, providing the one or more of at least the portion of the set of metadata and auxiliary data to a trained machine-learning module and obtaining, from the trained machine-learning model, the search space including a set of parameters.
